(19) United States
(12) Patent Application Publication
(10) Pub. No.: US 2024/0130556 A1
(43) Pub. Date: Apr. 25, 2024

(54) JUICING ACCESSORY AND APPARATUS INCORPORATING THE SAME

(71) Applicant: Namawell, LLC, Costa Mesa, CA (US)

(72) Inventor: Mark Anthony Thomas, New South Wales (AU)

(21) Appl. No.: 18/383,410

(22) Filed: Oct. 23, 2023

Related U.S. Application Data
(60) Provisional application No. 63/419,159, filed on Oct. 25, 2022.

(51) Int. Cl. A47J 19/02

(52) U.S. Cl. CPC A47J 19/023

(57) ABSTRACT

Embodiments of the present disclosure relate to food-processing assemblies, particularly juicing assemblies, and apparatuses incorporating the same. In an exemplary embodiment, a food-processing apparatus comprises: a food-processing accessory; an engaging portion of a motorized base adapted to receive the food-processing accessory; a motor drive extending from the engaging portion, the motor drive adapted to drive the food-processing accessory when mechanically coupled thereto; and a switch assembly disposed on the engaging portion of the motorized base, the switch assembly adapted to be actuated by a static actuation element of the food-processing accessory.

### CROSS-REFERENCE TO RELATED APPLICATION(S)

This application claims the benefit of priority of U.S. Provisional Patent Application No. 63/419,159, filed Oct. 25, 2022, the disclosure of which is hereby incorporated by reference herein in its entirety.

### TECHNICAL FIELD

The present disclosure relates to food-processing apparatuses, and more specifically, to accessories and apparatuses adapted for citrus juicing.

### BACKGROUND

It is common for hand-operated motorized citrus juicers and citrus juicer accessories to function in direct communication with a rotating drive shaft, connected to a motor. A hand operated citrus press typically operates via a switch located in direct communication with a citrus reamer component. Due to the relatively high torque of such motors, this can make positioning of citrus fruits difficult for a user who is not prepared for the immediate rotation of the citrus reamer when power is applied. Moreover, if an appliance has been designed for a different function and a safety switch is not mechanically associated with a drive shaft, then an alternative design is required for the citrus juicing accessory to operate within the electro-mechanical parameters of that appliance.

### SUMMARY

The following presents a simplified summary of various aspects of the present disclosure in order to provide a basic understanding of such aspects. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

In one aspect, a juicing accessory comprises: a collector tray; a filter tray seated at least partially within the collector tray; a spring-loaded reamer assembly coupled to and actuatable with respect to the filter tray, the spring-loaded reamer assembly comprising a first reamer element, and the spring-loaded reamer assembly comprising a motor engaging mechanism adapted to be coupled to a motor drive of a motorized base; and a static actuation element separate from the spring-loaded reamer assembly and disposed on a contact surface of the collector tray, the static actuation element adapted to engage a switch assembly when the juicing accessory is coupled to the motorized base, the switch assembly disposed on the motorized base. In at least one embodiment, the juicing accessory is in an operable state when both the spring-loaded reamer assembly and the static actuation element are engaged.

In at least one embodiment, the motor engaging mechanism comprises a coil spring to bias the first reamer element in a direction away from the filter tray. In at least one embodiment, when the juicing accessory is engaged with the motorized base, the motor engaging mechanism is adapted to engage the motor drive of the motorized base responsive to a downward force applied to the first reamer element and the coil spring. In at least one embodiment, when the juicing accessory is engaged with the motorized base, the weight of the juicing accessory is sufficient to actuate the switch assembly of the motorized base via the static actuation element without any additional external force being applied to the first reamer element and the coil spring.

In another aspect, a juicing accessory comprises: a collector tray; a filter tray seated at least partially within the collector tray; a reamer structure comprising a first reamer element, the reamer structure adapted to engage a load bearing aperture on the filter tray, and the reamer structure comprising a motor engaging mechanism adapted to be coupled to a motor drive of a motorized base; and a static actuation element separate from the reamer structure and disposed on a contact surface of the collector tray, the static actuation element adapted to engage a switch assembly when the juicing accessory is coupled to the motorized base, the switch assembly disposed on the motorized base. In at least one embodiment, the juicing accessory is in an operable state when both the reamer structure and the static actuation element are engaged with their respective parts.

In at least one embodiment, when the juicing accessory is engaged with the motorized base, the juicing accessory is adapted to actuate the switch assembly of the motorized base via the static actuation element responsive to a threshold force applied to the first reamer element.

In at least one of any of the preceding embodiments, the static actuation element is a rib structure protruding from a surface of the collector tray opposite the filter tray.

In at least one of any of the preceding embodiments, the juicing accessory further comprises a nozzle protruding from the collector tray.

In at least one of any of the preceding embodiments, the juicing accessory further comprises a second reamer element, the second reamer element adapted to be coupled to the first reamer element in a nested configuration.

In at least one of any of the preceding embodiments, the first reamer element comprises opposing paddle elements extending horizontally therefrom.

In another aspect, a food-processing apparatus comprises: a food-processing accessory; an engaging portion of a motorized base adapted to receive the food-processing accessory; a motor drive extending from the engaging portion, the motor drive adapted to drive the food-processing accessory when mechanically coupled thereto; and a switch assembly disposed on the engaging portion of the motorized base, the switch assembly adapted to be actuated by a static actuation element of the food-processing accessory responsive to a threshold force applied by the static actuation element when engaged therewith. In at least one embodiment, the switch assembly is adapted to electrically couple a motor of the motorized base to a power circuit responsive to actuation of the switch assembly.

In at least one embodiment, the food-processing accessory is a juicing accessory. In at least one embodiment, the food-processing accessory comprises the juicing accessory of any of the preceding embodiments. In at least one embodiment, the switch assembly comprises a microswitch encased at least partially by a sealing cover to prevent liquid spillage from entering the motorized base. In at least one embodiment, the switch assembly is disposed near a perimeter of the engaging portion away from the motor drive. In at least one embodiment, the switch assembly is the sole component of the engaging portion that is actuatable by the food-processing accessory.

### BRIEF DESCRIPTION OF THE DRAWINGS

The present disclosure is illustrated by way of example, and not by way of limitation, in the figures of the accompanying drawings, in which:

FIG. 1 illustrates a food-processing apparatus in accordance with at least one embodiment;

FIG. 2 is an exploded view of the juicing accessory in accordance with at least one embodiment;

FIG. 3 is a cross sectional view showing a juicing apparatus in a standby state in accordance with at least one embodiment;

FIG. 4 is a cross sectional view showing a juicing apparatus in an operational state in accordance with at least one embodiment;

FIG. 5A is a cross sectional view of a reamer assembly in a standby state in accordance with at least one embodiment;

FIG. 5B is a cross sectional view of a reamer assembly in an operational state in accordance with at least one embodiment;

FIG. 6 is a cross sectional view illustrating a further in accordance with at least one embodiment;

FIG. 7 is a cross sectional view of a reamer structure in a standby state in accordance with at least one embodiment

FIG. 8 is a cross sectional view of a reamer structure 202 in an operational state in accordance with at least one embodiment;

FIG. 9 illustrates a motorized base separated from a juicing accessory in accordance with at least one embodiment; and

FIG. 10 illustrates the motorized base receiving a different food-processing accessory in accordance with at least one embodiment.

### DETAILED DESCRIPTION

Described herein are food-processing assemblies, particularly juicing assemblies, and apparatuses incorporating the same. For example, certain embodiments are directed to a motorized citrus juicer having a rotatable reamer assembly/structure that is independent of safety switch actuation and functions only when a threshold force is applied to the reamer assembly/structure. Such embodiments allow a user the ability to position a citrus fruit accurately onto a reamer element, while a motor of a motorized base is simultaneously powered and its drive shaft is rotating without the reamer element also rotating. Further, such embodiments provide for improved manual control while juicing, and hence achieve improved juice yield.

These embodiments provide, but are not limited to, the following advantages: (1) avoiding the requirement to activate a switch assembly that powers the motor via movement of the reamer element, while providing the equivalent safety benefit of disengaging from the drive shaft; (2) providing citrus juicing capability for other appliances with an alternative application; and (3) allowing other motor driven accessories to be used on the same motor base, operable via a common switch assembly location, that do not require pressure applied by the user to activate the motor shaft.

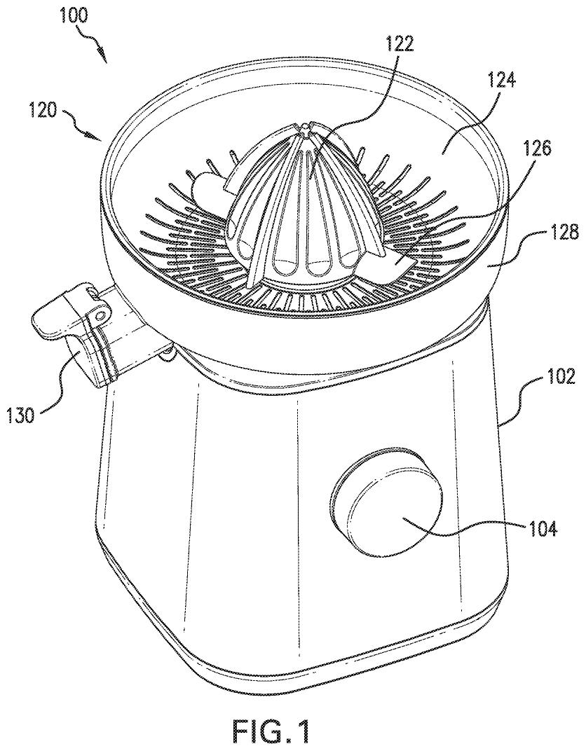

FIG. 1 illustrates a food-processing (e.g., juicing) apparatus 100 comprising a food-processing accessory (e.g., juicing accessory) 120 engaged with a motorized base 102 with a control dial assembly 104 (which may provide “On”/“Off” functionality and speed control). In at least one embodiment, a reamer element 122 rotates when downward force is applied by the user. A filter tray 124 sorts large portions of pulp fibre, preventing them from entering the juice. Reamer paddles 126 distribute pulp outwardly and upwardly to clear the filter tray 124 for the subsequent juicing of fruit. A collector tray 128 funnels juice toward an integrally-molded nozzle 130 comprising a sealed opening.

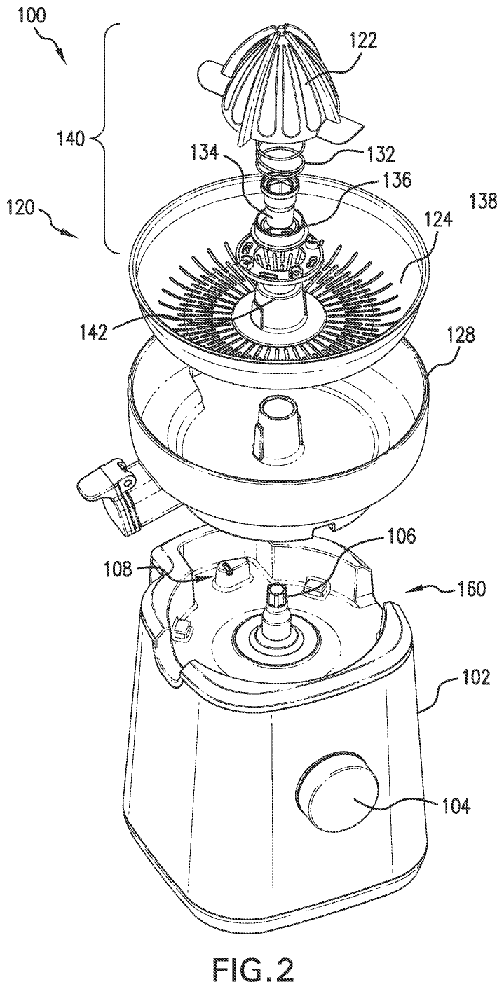

FIG. 2 illustrates an exploded view of the juicing accessory 120 including a spring-loaded reamer assembly 140 incorporating the reamer element 122, a coil spring 132, a drive coupling 134 (adapted for coupling to a motor drive 106 of the motorized base 102), a load plate 136, and a retaining ring 138. In at least one embodiment, the reamer assembly 140 is fastened by screws, or through any other suitable fastening mechanism as would be appreciated by those of ordinary skill in the art, such as one or more snap fastenings. In at least one embodiment, the filter tray 124 includes an integrally-molded or fastened inner aperture feature with a raised portion designed to resist liquid ingress onto or into the motorized base 102. In at least one embodiment, the filter tray 124 further includes an upwardly facing surface 142 around the aperture designed as a wearing contact face for the load plate 136 when downward pressure is applied to the reamer element 122. In other embodiments, such a surface may also similarly be integrated into a formed feature, surrounding a central aperture, in the collector tray 128.

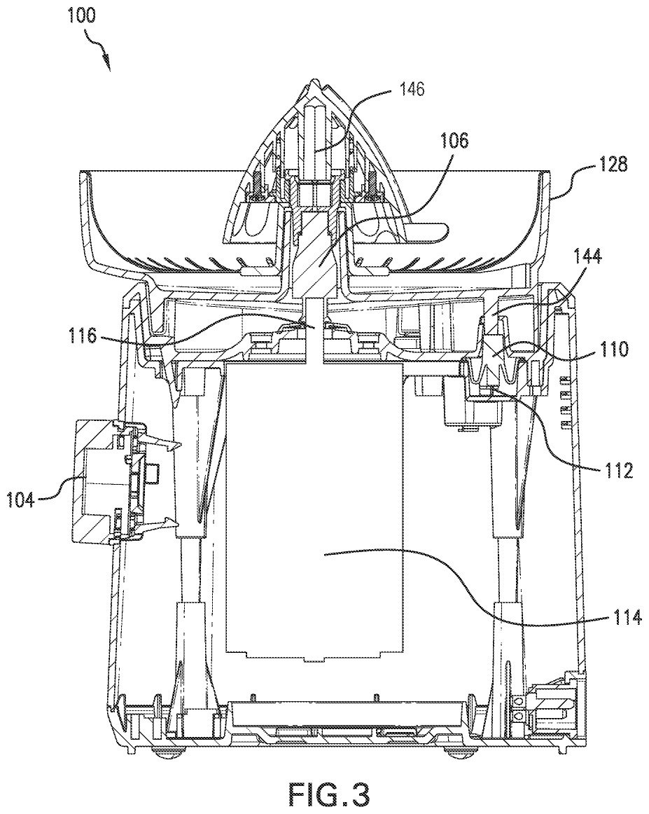

As illustrated, the motorized base 102 includes an engaging portion 160 with various features that are complementary to the components of the collector tray 128. The engaging portion 160 includes a switch assembly 108 that is engaged by an actuation element 144 (see FIG. 3) of the collector tray 128 when the juicing accessory 120 is engaged with the engaging portion 160.

FIG. 3 is a cross sectional view showing the juicing apparatus 100 in a standby state. In at least one embodiment, the actuation element 144 is an integrally-formed rib that extends from the collector tray 128, which can be used to depress a sealing cover 110 and a microswitch 112 of the switch assembly 108. In at least one embodiment, the sealing cover 110 prevents liquid ingress into the motorized base 102 covering the microswitch 112. In at least one embodiment, the collector tray 128 (or the entire juicing accessory 120), when engaged with the motorized base 102, can be sufficiently weighted to deform the upward spring force of the sealing cover 110, which in turn actuates the microswitch 112. As a result of such actuation, a power circuit is closed to allow for power to be provided to the motor 114. In at least one embodiment, rotation of the control dial assembly 104 to the ‘On’ position, together with actuation of the microswitch 112, completes the power circuit and causes a motor shaft 116 and the motor drive 106 to rotate. In at least one embodiment, when the motor 114 is powered, the drive coupling 134 rotates due engagement with motor drive 106. In such embodiments, the reamer element 122 remains stationary in this state because downward pressure is not applied and a drive detail 146 of the reamer assembly 140 has not yet engaged the drive coupling 134.

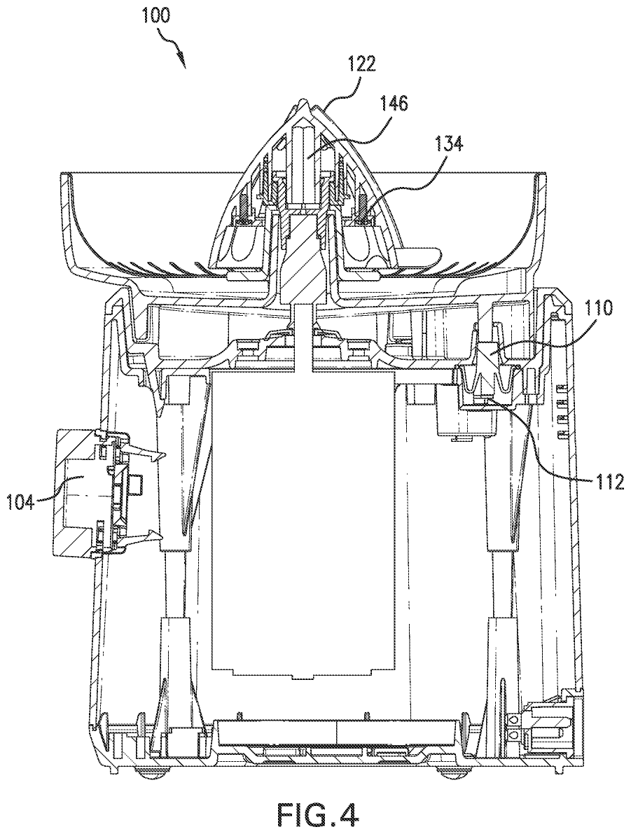

FIG. 4 is a cross sectional view showing the juicing apparatus 100 in an operational state. Rotation of the control dial assembly 104 to the ‘On’ position causes the motor shaft 116 and motor drive 106 to rotate. In such embodiments, the drive coupling 134 also rotates due engagement with motor drive 106. The reamer element 122 then rotates because downward pressure has been applied and the integrally-formed drive detail 146 of the reamer element 122 is now engaged with drive coupling 134.

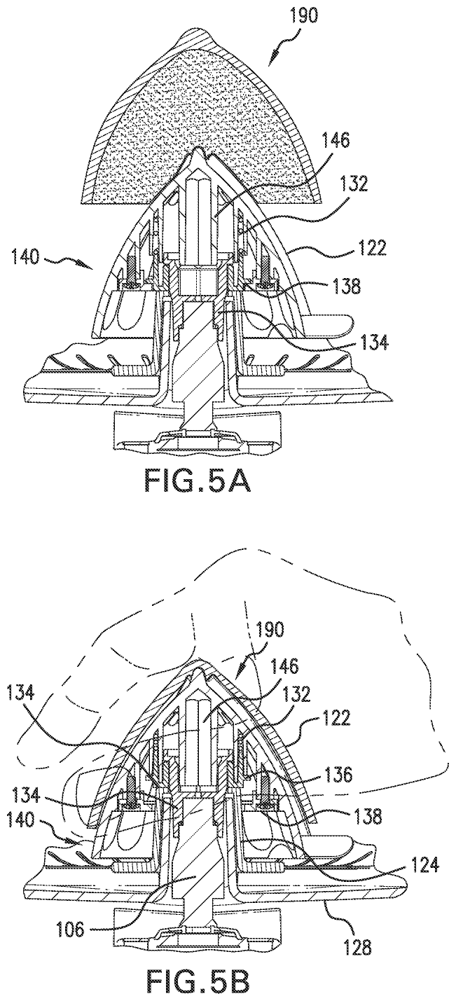

FIG. 5A is a cross sectional view of the reamer assembly 140 in the standby state, illustrating that the reamer assembly 140 will not commence rotation until a threshold pressure is applied in such embodiments. In at least one embodiment, the weight of an applied piece of fruit 190 will not activate the reamer assembly 140 because an upward resisting force is applied by coil spring 132, preventing the drive detail 146 from engaging with the drive coupling 134.

FIG. 5B is a cross sectional view of the reamer assembly 140 in an operational state, illustrating the upward threshold force applied by the coil spring 132 to the reamer element 122 being overcome by the user. A downward force is applied via the reamer element 122 and the coil spring 132 to the load plate 136. A face of load plate 136 acts upon a corresponding wearing face of the filter tray 124. The drive coupling 134 remains in its previous state, coupled to the motor drive 106, and the drive coupling 134 is retained within the reamer assembly 140 by the load plate 136, which in turn is retained within the reamer assembly 140 by the retaining ring 138. In at least one embodiment, the retaining ring 138 which is fastened by screws to the reamer element 122. This arrangement allows the spring loading functionality to be retained entirely within the reamer assembly 140, simplifying the filter tray 124, collector tray 128, and motorized base 102 components, as well as facilitating transference of the design to other appliances with different applications.

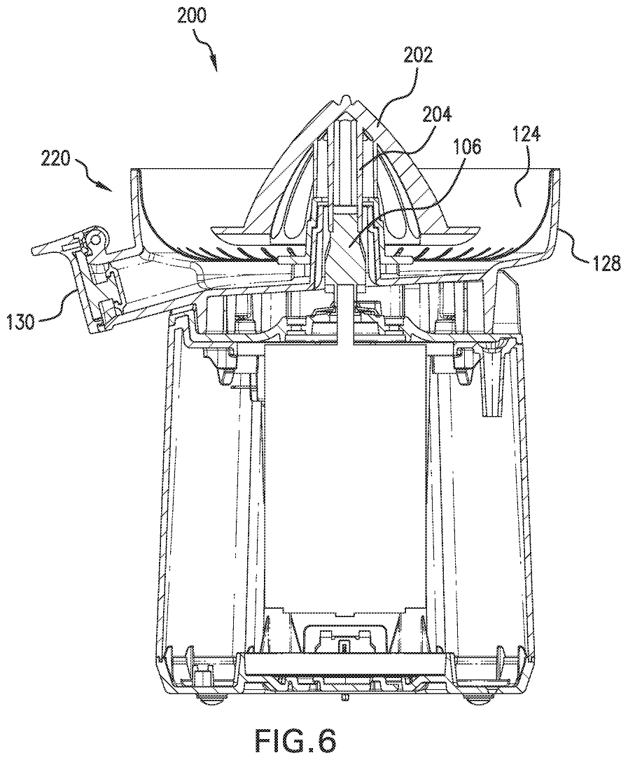

FIG. 6 is a cross sectional view illustrating a food-processing (e.g., juicing) apparatus 200 comprising a food-processing accessory (e.g., juicing accessory) 220 engaged with the same motorized base 102 described above with respect to FIGS. 1-5, in accordance with various other embodiments of the disclosure. These embodiment provide a similar functionality as the juicing apparatus 100, but with an alternative method for activation of the reamer functionality. In such embodiments, the weight of the juicing apparatus 200 may be designed to weigh less than the threshold force required to a actuate the sealing cover 110 and thus the microswitch 112. With hand force applied to the assembly, the sealing cover 110 deforms and activates the microswitch 112, in turn powering the motor 114. In at least one embodiment, such actuation is made possible through a moveable relationship between a reamer structure 202 and the motor shaft 116, with movement of the reamer structure 202 in turn contacting the filter tray 124 and the collector tray 128, subsequently actuating the microswitch 112 and commencing operation. In at least one embodiment, the juicing accessory 220 is removably engaged to the motorized base 102. In at least one embodiment, the reamer structure 202 includes an integrally formed drive receiving detail 204, which can provide a direct relationship between the rotation of the motor drive 106 and the reamer structure 202.

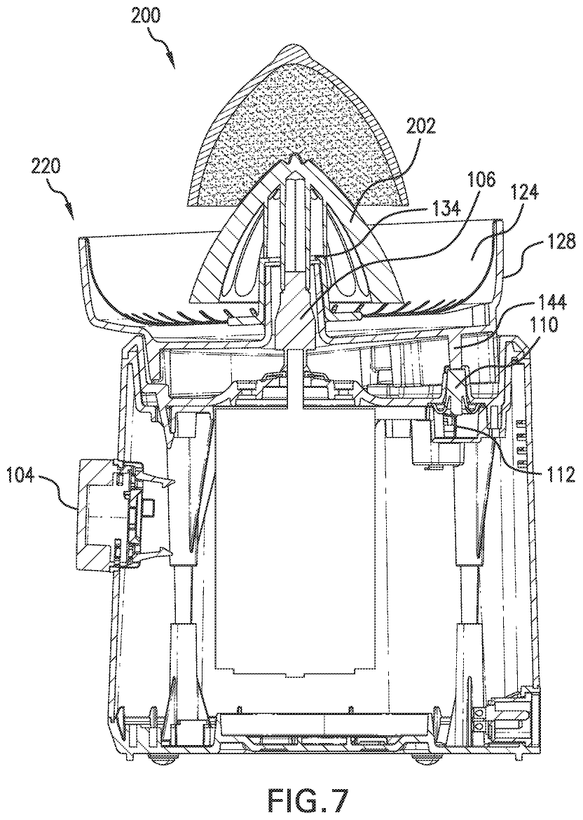

FIG. 7 is a cross sectional view of the reamer structure 202 in a standby state, illustrating that the reamer structure 202 will not commence rotation until a threshold pressure is applied. In such embodiments, the weight of an applied piece of fruit will not activate the rotational motion of the reamer structure 202 because an upward resisting force is applied by the sealing cover 110 onto the actuating element 144 of the collector tray 128. In at least one embodiment, the spring force required to overcome the sealing cover 110 may be designed as an upper threshold force that supports mounting of fruit to the reamer structure 202.

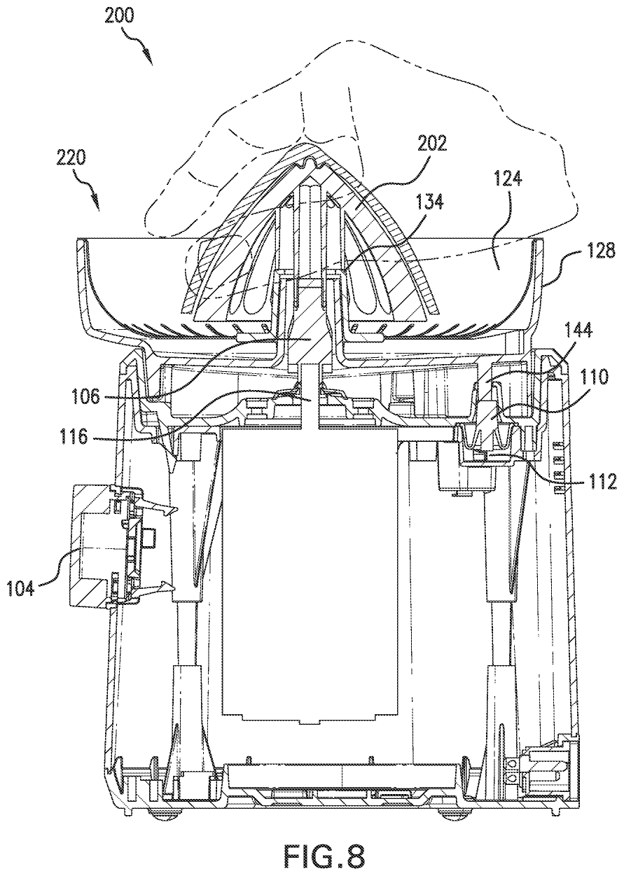

FIG. 8 is a cross sectional view of the reamer structure 202 in an operational state. In at least one embodiment, the upward threshold force applied by the sealing cover 110 to actuating element 144 of the collector tray 128 is overcome by the user pressing on the reamer structure 202. This occurs when downward force applied to the reamer structure 202 is transferred through the upwardly facing surface 142 of the filter tray 124. The filter tray 124, then acting upon the collector tray 128, causes the entire juicing accessory 220 to move toward the motorized base 102, sufficiently overcoming the threshold force of the sealing cover 110 and actuating the microswitch 112. In at least one embodiment, once the motor is activated, the user may operate the reamer structure 202 via the control dial assembly 104 by turning it to the ‘On’ position. In at least one other embodiment, the user may have pre-set the control dial assembly 104 to an ‘On’ position upon which the reamer structure 202 will rotate with immediate downward pressure applied by the user. In such embodiments, movement of the juicing accessory 220 is also facilitated by movement of the drive coupling 134 relative to the motor shaft 116. For example, the drive coupling 134 can itself be spring loaded (not shown).

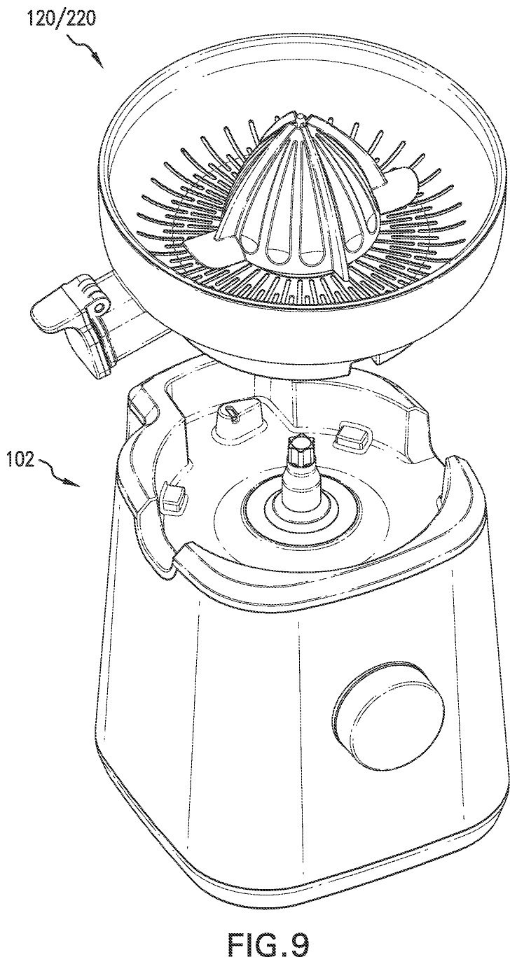

FIG. 9 illustrates the motorized base 102 and either embodiment of the juicing accessory 120 or 220 separated therefrom.

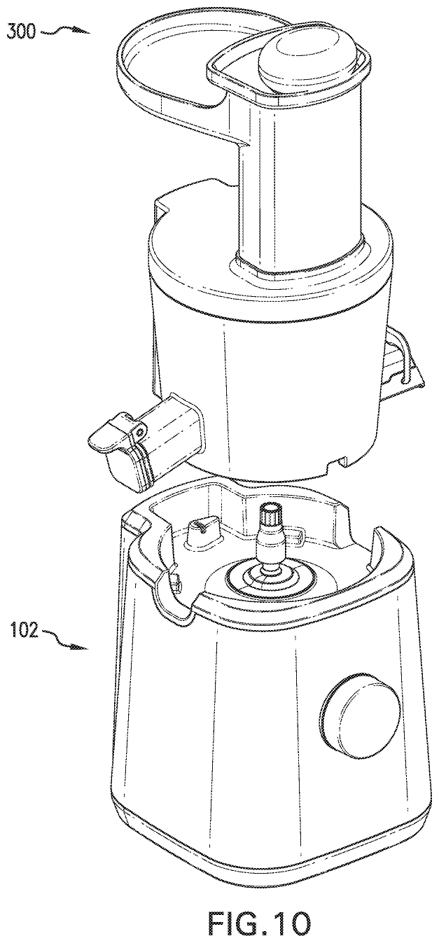

FIG. 10 illustrates the motorized base 102 receiving a different food-processing accessory 300, such as a slow juicing accessory, demonstrating alternative accessory applications using a shared motorized base with a switch assembly not associated with the motor shaft.

The following exemplary embodiments are now described:

Embodiment 1: A juicing accessory, comprising: a collector tray; a filter tray seated at least partially within the collector tray; a spring-loaded reamer assembly coupled to and actuatable with respect to the filter tray, the spring-loaded reamer assembly comprising a first reamer element, and the spring-loaded reamer assembly comprising a motor engaging mechanism adapted to be coupled to a motor drive of a motorized base; and a static actuation element separate from the spring-loaded reamer assembly and disposed on a contact surface of the collector tray, the static actuation element adapted to engage a switch assembly when the juicing accessory is coupled to the motorized base, the switch assembly disposed on the motorized base, wherein the juicing accessory is in an operable state when both the spring-loaded reamer assembly and the static actuation element are engaged.

Embodiment 2: The juicing accessory of Embodiment 1, wherein the static actuation element is a rib structure protruding from a surface of the collector tray opposite the filter tray.

Embodiment 3: The juicing accessory of any of Embodiments 1-2, further comprising: a nozzle protruding from the collector tray.

Embodiment 4: The juicing accessory of any of Embodiments 1-3, further comprising a second reamer element, the second reamer element adapted to be coupled to the first reamer element in a nested configuration.

Embodiment 5: The juicing accessory of any of Embodiments 1-4, wherein the first reamer element comprises opposing paddle elements extending horizontally therefrom.

Embodiment 6: The juicing accessory of any of Embodiments 1-5, wherein the motor engaging mechanism comprises a coil spring to bias the first reamer element in a direction away from the filter tray.

Embodiment 7: The juicing accessory of Embodiment 6, wherein, when the juicing accessory is engaged with the motorized base, the motor engaging mechanism is adapted to engage the motor drive of the motorized base responsive to a downward force applied to the first reamer element and the coil spring.

Embodiment 8: The juicing accessory of Embodiment 7, wherein, when the juicing accessory is engaged with the motorized base, the weight of the juicing accessory is sufficient to actuate the switch assembly of the motorized base via the static actuation element without any additional external force being applied to the first reamer element and the coil spring.

Embodiment 9: A juicing accessory, comprising: a collector tray; a filter tray seated at least partially within the collector tray; a reamer structure comprising a first reamer element, the reamer structure adapted to engage a load bearing aperture on the filter tray, and the reamer structure comprising a motor engaging mechanism adapted to be coupled to a motor drive of a motorized base; and a static actuation element separate from the reamer structure and disposed on a contact surface of the collector tray, the static actuation element adapted to engage a switch assembly when the juicing accessory is coupled to the motorized base, the switch assembly disposed on the motorized base, wherein the juicing accessory is in an operable state when both the reamer structure and the static actuation element are engaged.

Embodiment 10: The juicing accessory of Embodiment 9, wherein the static actuation element is a rib structure protruding from a surface of the collector tray opposite the filter tray.

Embodiment 11: The juicing accessory of any of Embodiments 9-10, further comprising: a nozzle protruding from the collector tray.

Embodiment 12: The juicing accessory of any of Embodiments 9-11, further comprising a second reamer element, the second reamer element adapted to be coupled to the first reamer element in a nested configuration.

Embodiment 13: The juicing accessory of Embodiments 9-12, wherein the first reamer element comprises opposing paddle elements extending horizontally therefrom.

Embodiment 14: The juicing accessory of Embodiments 9-13, wherein, when the juicing accessory is engaged with the motorized base, the juicing accessory is adapted to actuate the switch assembly of the motorized base via the static actuation element responsive to a threshold force applied to the first reamer element.

Embodiment 15: A food-processing apparatus, comprising: a food-processing accessory; an engaging portion of a motorized base adapted to receive the food-processing accessory; a motor drive extending from the engaging portion, the motor drive adapted to drive the food-processing accessory when mechanically coupled thereto; and a switch assembly disposed on the engaging portion of the motorized base, the switch assembly adapted to be actuated by a static actuation element of the food-processing accessory responsive to a threshold force applied by the static actuation element when engaged therewith, wherein the switch assembly is adapted to electrically couple a motor of the motorized base to a power circuit responsive to actuation of the switch assembly.

Embodiment 16: The food-processing apparatus of Embodiment 15, wherein the switch assembly comprises a microswitch encased at least partially by a sealing cover to prevent liquid spillage from entering the motorized base.

Embodiment 17: The food-processing apparatus of any of Embodiments 15-16, wherein the switch assembly is disposed near a perimeter of the engaging portion away from the motor drive, and wherein the switch assembly is the sole component of the engaging portion that is actuatable by the food-processing accessory.

Embodiment 18: The food-processing apparatus of any of Embodiments 15-17, wherein the food-processing accessory is a juicing accessory comprising: a collector tray; a filter tray seated at least partially within the collector tray; a spring-loaded reamer assembly coupled to and actuatable with respect to the filter tray, the spring-loaded reamer assembly comprising a first reamer element, and the spring-loaded reamer assembly comprising a motor engaging mechanism adapted to be coupled to the motor drive of the motorized base; and the static actuation element, wherein the static actuation element is separate from the spring-loaded reamer assembly and disposed on a contact surface of the collector tray, wherein the static actuation element adapted to engage the switch assembly disposed on the motorized base when the juicing accessory is coupled to the motorized base, and wherein the juicing accessory is in an operable state when both the spring-loaded reamer assembly and the static actuation element are engaged.

Embodiment 19: The food-processing apparatus of any of Embodiments 15-17, wherein the food-processing accessory is a juicing accessory comprising: a collector tray; a filter tray seated at least partially within the collector tray; a reamer structure comprising a first reamer element, the reamer structure adapted to engage a load bearing aperture on the filter tray, and the reamer structure comprising a motor engaging mechanism adapted to be coupled to the motor drive of the motorized base; and the static actuation element, wherein the static actuation element is separate from the reamer structure and disposed on a contact surface of the collector tray, wherein the static actuation element adapted to engage the switch assembly disposed on the motorized base when the juicing accessory is coupled to the motorized base, and wherein the juicing accessory is in an operable state when both the reamer structure and the static actuation element are engaged.

Embodiment 20: The food-processing apparatus of any of Embodiments 15-17, wherein the food-processing accessory comprises a slow juicing accessory.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Reference throughout this specification to “certain embodiments,” “one embodiment,” “at least one embodiment,” or the like means that a particular feature, structure, or characteristic described in connection with the embodiment is included in at least one embodiment. Thus, the appearances of the phrase “certain embodiments,” “one embodiment,” “at least one embodiment,” or the like in various places throughout this specification are not necessarily all referring to the same embodiment.

The present disclosure is not to be limited in scope by the specific embodiments described herein. Indeed, other various embodiments of and modifications to the present disclosure, in addition to those described herein, will be apparent to those of ordinary skill in the art from the description and accompanying drawings. Thus, such other embodiments and modifications are intended to fall within the scope of the present disclosure. Further, while the present disclosure has been described in the context of a particular embodiment in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein, along with the full scope of equivalents to which such claims are entitled.

What is claimed is:

1. A juicing accessory, comprising:
a collector tray;
a filter tray seated at least partially within the collector tray;
a spring-loaded reamer assembly coupled to and actuatable with respect to the filter tray, the spring-loaded reamer assembly comprising a first reamer element, and the spring-loaded reamer assembly comprising a motor engaging mechanism adapted to be coupled to a motor drive of a motorized base; and
a static actuation element separate from the spring-loaded reamer assembly and disposed on a contact surface of the collector tray, the static actuation element adapted to engage a switch assembly when the juicing accessory is coupled to the motorized base, the switch assembly disposed on the motorized base,
wherein the juicing accessory is in an operable state when both the spring-loaded reamer assembly and the static actuation element are engaged.

2. The juicing accessory of claim 1, wherein the static actuation element is a rib structure protruding from a surface of the collector tray opposite the filter tray.

3. The juicing accessory of claim 1, further comprising:
a nozzle protruding from the collector tray.

4. The juicing accessory of claim 1, further comprising a second reamer element, the second reamer element adapted to be coupled to the first reamer element in a nested configuration.

5. The juicing accessory of claim 1, wherein the first reamer element comprises opposing paddle elements extending horizontally therefrom.

6. The juicing accessory of claim 1, wherein the motor engaging mechanism comprises a coil spring to bias the first reamer element in a direction away from the filter tray.

7. The juicing accessory of claim 6, wherein, when the juicing accessory is engaged with the motorized base, the motor engaging mechanism is adapted to engage the motor drive of the motorized base responsive to a downward force applied to the first reamer element and the coil spring.

8. The juicing accessory of claim 7, wherein, when the juicing accessory is engaged with the motorized base, the weight of the juicing accessory is sufficient to actuate the switch assembly of the motorized base via the static actuation element without any additional external force being applied to the first reamer element and the coil spring.

9. A juicing accessory, comprising:
a collector tray;
a filter tray seated at least partially within the collector tray;
a reamer structure comprising a first reamer element, the reamer structure adapted to engage a load bearing aperture on the filter tray, and the reamer structure comprising a motor engaging mechanism adapted to be coupled to a motor drive of a motorized base; and
a static actuation element separate from the reamer structure and disposed on a contact surface of the collector tray, the static actuation element adapted to engage a switch assembly when the juicing accessory is coupled to the motorized base, the switch assembly disposed on the motorized base,
wherein the juicing accessory is in an operable state when both the reamer structure and the static actuation element are engaged.

10. The juicing accessory of claim 9, wherein the static actuation element is a rib structure protruding from a surface of the collector tray opposite the filter tray.

11. The juicing accessory of claim 9, further comprising:
a nozzle protruding from the collector tray.

12. The juicing accessory of claim 9, further comprising a second reamer element, the second reamer element adapted to be coupled to the first reamer element in a nested configuration.

13. The juicing accessory of claim 9, wherein the first reamer element comprises opposing paddle elements extending horizontally therefrom.

14. The juicing accessory of claim 9, wherein, when the juicing accessory is engaged with the motorized base, the juicing accessory is adapted to actuate the switch assembly of the motorized base via the static actuation element responsive to a threshold force applied to the first reamer element.

15. A food-processing apparatus, comprising:
a food-processing accessory;
an engaging portion of a motorized base adapted to receive the food-processing accessory;
a motor drive extending from the engaging portion, the motor drive adapted to drive the food-processing accessory when mechanically coupled thereto; and
a switch assembly disposed on the engaging portion of the motorized base, the switch assembly adapted to be actuated by a static actuation element of the food-processing accessory responsive to a threshold force applied by the static actuation element when engaged therewith, wherein the switch assembly is adapted to electrically couple a motor of the motorized base to a power circuit responsive to actuation of the switch assembly.

16. The food-processing apparatus of claim 15, wherein the switch assembly comprises a microswitch encased at least partially by a sealing cover to prevent liquid spillage from entering the motorized base.

17. The food-processing apparatus of claim 15, wherein the switch assembly is disposed near a perimeter of the engaging portion away from the motor drive, and wherein the switch assembly is the sole component of the engaging portion that is actuatable by the food-processing accessory.

18. The food-processing apparatus of claim 15, wherein the food-processing accessory is a juicing accessory comprising:
a collector tray;
a filter tray seated at least partially within the collector tray;
a spring-loaded reamer assembly coupled to and actuatable with respect to the filter tray, the spring-loaded reamer assembly comprising a first reamer element, and the spring-loaded reamer assembly comprising a motor engaging mechanism adapted to be coupled to the motor drive of the motorized base; and
the static actuation element, wherein the static actuation element is separate from the spring-loaded reamer assembly and disposed on a contact surface of the collector tray, wherein the static actuation element adapted to engage the switch assembly disposed on the motorized base when the juicing accessory is coupled to the motorized base, and wherein the juicing accessory is in an operable state when both the spring-loaded reamer assembly and the static actuation element are engaged.

19. The food-processing apparatus of claim 15, wherein the food-processing accessory is a juicing accessory comprising:
a collector tray;
a filter tray seated at least partially within the collector tray;
a reamer structure comprising a first reamer element, the reamer structure adapted to engage a load bearing aperture on the filter tray, and the reamer structure comprising a motor engaging mechanism adapted to be coupled to the motor drive of the motorized base; and
the static actuation element, wherein the static actuation element is separate from the reamer structure and disposed on a contact surface of the collector tray, wherein the static actuation element adapted to engage the switch assembly disposed on the motorized base when the juicing accessory is coupled to the motorized base, and wherein the juicing accessory is in an operable state when both the reamer structure and the static actuation element are engaged.

20. The food-processing apparatus of claim 15, wherein the food-processing accessory comprises a slow juicing accessory.
